(19) United States
(12) Patent Application Publication
(10) Pub. No.: US 2025/0360964 A1
(43) Pub. Date: Nov. 27, 2025

(54) VEHICLE BODY FRAME STRUCTURE FOR VEHICLE

(71) Applicant: Mazda Motor Corporation, Hiroshima (JP)

(72) Inventors: Eiji KAMEMOTO, Aki-gun, Hiroshima (JP); Hirotaka NATSUME, Aki-gun, Hiroshima (JP); Hideyuki TSUKAMOTO, Aki-gun, Hiroshima (JP); Yoshikazu NISHIMURA, Aki-gun, Hiroshima (JP)

(73) Assignee: Mazda Motor Corporation, Hiroshima (JP)

(21) Appl. No.: 19/211,306

(22) Filed: May 19, 2025

(30) Foreign Application Priority Data
May 22, 2024 (JP) 2024-083021

(51) Int. Cl. B62D 21/03; B60R 16/04; B62D 25/02; B62D 25/20

(52) U.S. Cl. CPC B62D 21/03; B60R 16/04; B62D 25/025; B62D 25/2036

(57) ABSTRACT

The vehicle body frame structure for a vehicle includes a side sill extending in a vehicle front-rear direction and a reinforcing member in a hollow section of the side sill. The reinforcing member is formed such that plural closed cross-sectional cells, each of which has an axis in a vehicle width direction, continue in the vehicle front-rear direction. The plural closed cross-sectional cells each have an n-sided polygon (n: an even number of 4 or greater) closed cross section such that the closed cross-sectional cells adjacent in the vehicle front-rear direction share a first cell wall. A side length of the first cell wall in each cell is longer than a side length of at least one cell wall of cell walls other than the first cell wall of the cell.

### CROSS-REFERENCE TO RELATED APPLICATION

The present application claims priority to Japanese application number 2024-083021 filed in the Japanese Patent Office on May 22, 2024, the entire contents of which are incorporated herein by reference.

### TECHNICAL FIELD

The present disclosure relates to a vehicle body frame structure for a vehicle.

### BACKGROUND ART

A vehicle such as an automobile includes a vehicle body to which plural frame members are joined. The frame members that constitute a frame of the vehicle body are each required to secure high rigidity while suppressing a weight increase.

Patent Literature 1 discloses a vehicle body structure that includes a hollow side sill and a reinforcing member that is disposed in the side sill. The reinforcing member that is adopted for the vehicle body structure in Patent Literature 1 will be described with reference to FIG. 8(a).

As illustrated in FIG. 8(a), a reinforcing member 903 in Patent Literature 1 is formed by using two plate members (an upper plate member 904 and a lower plate member 905), each of which is bent. The reinforcing member 903 has plural closed cross-sectional cells 903a that are arranged along a longitudinal direction of the side sill (a front-rear direction of the vehicle). Each of the plural closed cross-sectional cell 903a has a hollow columnar shape that extends in a direction orthogonal to a sheet of FIG. 8(a), and has a hexagonal shape (a honeycomb shape) in a side view. In the reinforcing member 903, a joint portion 903b that joins the upper plate member 904 and the lower plate member 905 is provided between each adjacent pair of the adjacent closed cross-sectional cells 903a. In the joined portion 903b, the upper plate member 904 and the lower plate member 905 are superimposed on and joined to each other by welding or the like.

Here, as a measure for improving energy absorption performance at the time when a collision load is input to the side sill from an outer side in a vehicle width direction in Patent Literature 1, it is considered to continuously dispose the adjacent closed cross-sectional cells 903a and expand a disposition area in a height direction. More specifically, as illustrated in FIG. 8(b), a considered reinforcing member 953 can be formed by using three plate members (an upper plate member 954, an intermediate plate member 955, and a lower plate member 956), each of which extends in the longitudinal direction of the side sill and is bent. In this way, the reinforcing member 953 can be configured to have plural closed cross-sectional cells 953a, 953b that are continuously disposed in the front-rear direction of the vehicle with slant wall sections 955a to 955d of the intermediate plate member 955 being interposed therebetween, and to have a height L95 that is greater than that of the reinforcing member 903 illustrated in FIG. 8(a). In the thus-structured reinforcing member 953, the closed cross-sectional cells 953a, 953b, each of which has the honeycomb shape, can continue, and an area in a height direction can expand to be larger than the reinforcing member 903 in Patent Literature 1.

### CITATION LIST

### Patent Literature

[Patent Literature 1] JP2021-24350A

### SUMMARY

### Technical Problems

However, it is difficult to increase an energy absorption amount (an EA amount) of the reinforcing member 953 illustrated in FIG. 8(b) when the collision load is input to the side sill as the frame member from the outer side in the vehicle width direction. In other words, in the reinforcing member 953 in which the plural closed cross-sectional cells 953a, 953b continue in a zigzag shape, each of the closed cross-sectional cells 953a, 953b is small, and axial compression becomes unstable. Thus, it is difficult to increase the energy absorption amount of the reinforcing member 953 at the time when the collision load is input from the outer side in the vehicle width direction.

In addition, it is difficult to reduce weight and cut manufacturing cost of the reinforcing member 953 illustrated in FIG. 8(b). That is, in the reinforcing member 953, since each of the plate members 954 to 956 are bent such that the plural closed cross-sectional cells 953a, 953b continue in the zigzag shape, an actual length of each of the plate members 954 to 956 is long. This naturally increases the weight of the reinforcing member 953, and thus the weight reduction thereof is difficult. In addition, the reinforcing member 953 has a large number of joining portions (wall portions 954a, 955e to 955g, 956a, 956b) where the plate members 954 to 956 are superimposed on each other, and thus complicated work is required during manufacturing. Therefore, it is difficult to reduce the manufacturing cost of the reinforcing member 953.

The disclosure is directed to solving one or more of the problems as described above, and embodiments provide a vehicle body frame structure for a vehicle capable of realizing a high collision energy absorption property while suppressing increases in weight and manufacturing cost.

### Solutions to Problems

A vehicle body frame structure according to an aspect of the invention includes a frame member and a reinforcing member. The frame member is a member that constitutes a frame of a vehicle body, has a hollow section therein, and extends in a first direction. The reinforcing member is a reinforcing member that is accommodated in the hollow section of the frame member, and has plural cells, each of which is formed in a hollow columnar shape having an axis in a second direction intersecting the first direction by plural cell walls, and is formed such that the plural cells are arranged continuously in the first direction.

In the vehicle body frame structure for a vehicle according to the present aspect, the plural cells in the reinforcing member each have an n-sided polygon (n: an even number of 4 or greater) in an orthogonal cross section to the second direction, and are formed such that the adjacent cells in the first direction share the cell wall. In the case where the cell wall that is shared by the adjacent cells is set as a first cell wall, each of the plural cells is formed such that a side length of the first cell wall in the orthogonal cross section is longer than a side length of at least one cell wall of the other cell walls that form the cell.

In the vehicle, to which the vehicle body frame structure according to the above aspect is applied, since each of the cells is formed such that the side length of the first cell wall is longer than the side length of the at least one cell wall, it is possible to secure a large cross-sectional area of the closed cross section in each of the cells while continuously arranging the cells each having the n-sided polygonal cross section in the first direction in comparison with a case where plural cells each having a regular n-sided polygonal shape are formed. Therefore, in the vehicle according to the above aspect, compared to a case where a configuration as illustrated in FIG. 8(b) is adopted, it is possible to realize a high collision energy absorption property while suppressing increases in weight and manufacturing cost.

In the vehicle body frame structure according to the above aspect, not a circle is inscribed in the closed cross section of each of the cells, but an oval or an ellipse is inscribed therein. However, there is a case where the shape of the cell is defined in a mode that the ellipse or the like is not inscribed in all the cell walls forming the cell and the ellipse or the like is not inscribed in at least one of the cell walls. In the vehicle body frame structure according to the above aspect, by adopting such a cell shape, operational effects as described above can be exerted.

In the vehicle body frame structure for a vehicle according to the above aspect, such a configuration may be adopted that, in the orthogonal cross section, in the case where a direction that is orthogonal to the first direction is set as a third direction, each of the plural cells has a hexagonal shape in the orthogonal cross section, and has: paired second cell walls that extend in the first direction and oppose in the third direction; and paired third cell walls, each of which connects an end side in the first direction of one cell wall of the paired second cell walls and a respective end side in the third direction of a pair of the first cell walls, and each of the plural cells is formed such that the side length of the first cell wall is longer than a side length of the third cell wall. That is, in the vehicle body frame structure according to the present aspect, the cell has the hexagonal shape in the cross section, and the at least one cell wall is the third cell wall.

In the vehicle, to which the vehicle body frame structure according to the above aspect is applied, the closed cross-sectional shape of each of the cells is the hexagonal shape, and each of the cells is configured that each of the side lengths of the paired first cell walls is longer than the side length of the third cell wall. Thus, compared to a case where the cell structures in the regular hexagonal shapes continue as illustrated in FIG. 8(b), it is possible to make the plural cells continue in the first direction while securing the large cross-sectional area of the hexagonal cell.

In the vehicle body frame structure for a vehicle according to the above aspect, such a configuration may be adopted that the frame member is a side sill that is disposed on an outer side in a vehicle width direction of a floor section of the vehicle and is formed to extend in a front-rear direction of the vehicle, a cross member, one end of which is connected to the side sill, and which extends in the vehicle width direction, is disposed in the floor section of the vehicle, and in a side view from a side of the vehicle, the reinforcing member is disposed in an area that overlaps the cross member.

In the vehicle, to which the vehicle body frame structure according to the above aspect is applied, since the reinforcing member is disposed in the area that overlaps the cross member in the side view from the side, when a collision load is input from a side of the vehicle to the side sill as the frame member, the load is highly efficiently transmitted to the cross member via the reinforcing member. Thus, in the vehicle, to which the vehicle body frame structure according to the above aspect is applied, even when the side collision load is input to the side sill on one side in the vehicle width direction, the load is transmitted to the side sill on an opposite side via the cross member, and energy can be absorbed highly efficiently.

In the vehicle body frame structure for a vehicle according to the above aspect, such a configuration may be adopted that a battery is disposed in the floor section, and the battery is fixed to the side sill.

In the vehicle, to which the vehicle body frame structure according to the above aspect is applied, since the battery is fixed to the side sill having high rigidity, the battery is securely held even when vibration is applied during travel of the vehicle, or the like. In the above vehicle, even when the side collision load is input to the side sill as described above, the energy is absorbed highly efficiently by the reinforcing member, and the load is transmitted to the cross member. Thus, it is possible to suppress the battery from being damaged during the side collision.

In the vehicle body frame structure for a vehicle according to the above aspect, such a configuration may be adopted that the reinforcing member is formed by fixing three plate members, each of which extends in the first direction and is bent, to each other.

In the vehicle, to which the vehicle body frame structure according to the above aspect is applied, since the reinforcing member is formed by using the three plate members, it is possible to form the reinforcing member in a simpler manufacturing process than in a case where the reinforcing member is integrally formed by casting or the like. In addition, even when a vehicle type is different, or design is changed, or the like, the reinforcing member can be formed by flexibly changing the shape in comparison with the case where the reinforcing member is formed by casting or the like.

In the vehicle body frame structure for a vehicle according to the above aspect, such a configuration is adopted that the three plate members include a first plate member, a second plate member, and a third plate member that are disposed from one side toward the other side in the third direction, in each of the plural cells, the first plate member and the third plate member form the paired second cell walls and the paired third cell walls, and in each of the plural cells, the second plate member forms the paired first cell walls.

In the vehicle, to which the vehicle body frame structure according to the above aspect is applied, each of the first cell walls in the plural cells is formed by the second plate member. Thus, it is possible to realize the configuration of the reinforcing member in an optimum shape by the bent shape of the second plate member while considering the collision energy absorption property.

In the vehicle having the vehicle body frame structure according to each of the above aspects, it is possible to realize the high collision energy absorption property while suppressing the increases in weight and manufacturing cost.

### BRIEF DESCRIPTION OF DRAWINGS

FIG. 1 is a plan view illustrating a partial configuration of a vehicle, to which a vehicle body frame structure according to an embodiment of the invention is applied.

FIG. 2 is a cross-sectional view illustrating a cross section that is taken along line II-II in FIG. 1.

FIG. 3 is a cross-sectional view illustrating a cross section that is taken along line III-III in FIG. 2.

FIG. 4 is an exploded perspective view illustrating a configuration of a reinforcing member.

FIG. 5 is a cross-sectional view illustrating a partial configuration of the reinforcing member.

FIG. 6 is a cross-sectional view illustrating a positional relationship between the reinforcing member and a cross member.

FIG. 7(a) is a cross-sectional view illustrating a partial configuration of a reinforcing member in a vehicle body frame structure according to a first modified example, and FIG. 7(b) is a cross-sectional view illustrating a partial configuration of a reinforcing member in a vehicle body frame structure according to a second modified example.

FIG. 8(a) is a cross-sectional view illustrating a partial configuration of a reinforcing member that is adopted for a vehicle body frame structure according to the related art, and FIG. 8(b) is a cross-sectional view illustrating a partial configuration of another reinforcing member that is assumed from the related art.

### DESCRIPTION OF EMBODIMENTS

A description will hereinafter be made on an embodiment of the invention with reference to the drawings. The disclosure will be exemplified in the embodiment described below, and the disclosure is not limited to the following embodiment in all respects except for an essential configuration thereof.

In the drawings used in the following description, “FR” indicates a vehicle front direction, “RR” indicates a vehicle rear direction, “LH” indicates a vehicle left direction, “RH” indicates a vehicle right direction, “UP” indicates a vehicle up direction, and “LO” indicates a vehicle down direction. Furthermore, in the following description, a vehicle front-rear direction will simply be described as a “front-rear direction”, and a vehicle up-down direction will simply be described as an “up-down direction”.

### Embodiment

### 1. Configuration of Vehicle 1

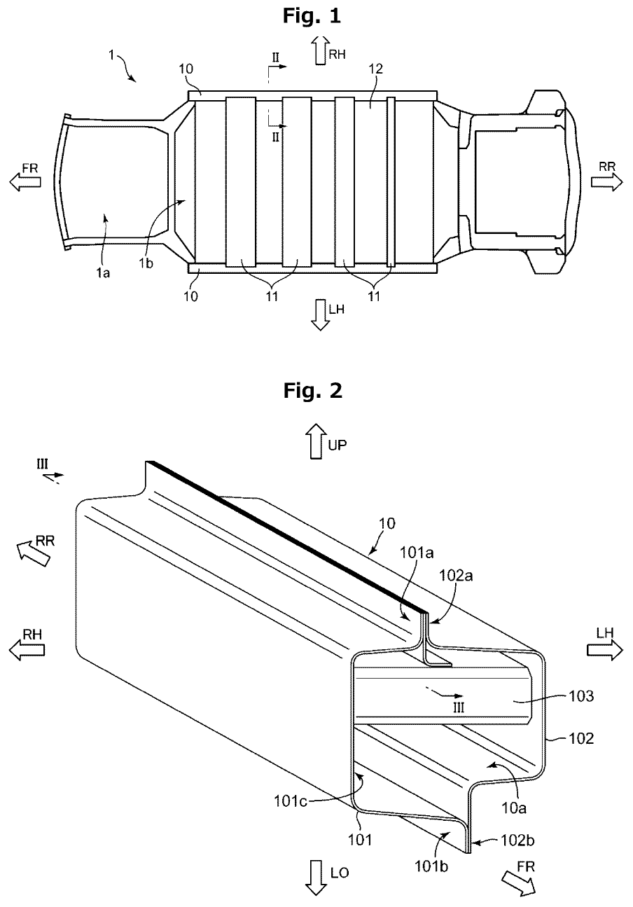

A description will be made on a configuration of a vehicle 1, to which a vehicle body structure according to the present embodiment is applied, with reference to FIG. 1. FIG. 1 illustrates only a part of the configuration of the vehicle 1 and does not illustrate a powertrain and the like.

As illustrated in FIG. 1, the vehicle 1 includes a powertrain mounting section la, on which the powertrain is mounted, in a front portion, and includes a floor section 1b, which is an area where an occupant rides, behind the powertrain mounting section 1a. Paired side sills (frame members) 10, plural cross members 11, and a battery 12 are disposed in the floor section 11b.

The paired side sills 10 are disposed on both sides of the floor section 1b in a vehicle width direction and are each formed to extend in the front-rear direction. Each of the plural cross members 11 extends in the vehicle width direction and is fixed to the side sills 10. The battery 12 sends/receives electric power to/from the powertrain (not illustrated).

Here, the battery 12 includes: a battery cell configured by a lithium-ion battery, a nickel-metal hydride battery, or the like; and a battery casing that accommodates the battery cell.

### 2. Internal Structure of Side Sill 10

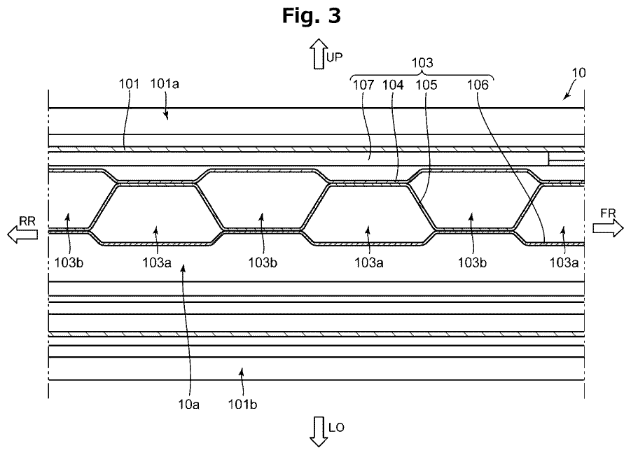

A description will be made on an internal structure of the side sill 10 with reference to FIG. 2 and FIG. 3. In FIG. 2 and FIG. 3, only the right side sill 10 of the paired side sills 10 is illustrated. However, the left side sill 10 has the same internal structure as the right side sill 10 except that the left and right sides are reversed.

As illustrated in FIG. 2, the side sill 10 is configured by fixing an outer side sill 101 and an inner side sill 102, each of which has a hat cross-sectional shape, to each other. The side sill 10 has a closed cross-sectional structure that has a hollow section 10a therein by fixing the outer side sill 101 and the inner side sill 102.

The outer side sill 101 and the inner side sill 102 have flange sections 101a, 101b and 102a, 102b in the up-down direction, respectively. The outer side sill 101 and the inner side sill 102 are fixed by fixing the upper flange sections 101a and 102a and fixing the lower flange sections 101b and 102b.

A reinforcing member 103 is accommodated in the hollow section 10a of the side sill 10. As illustrated in FIG. 3, the reinforcing member 103 is configured with plural closed cross-sectional cells 103a, 103b continue in the front-rear direction. As illustrated in FIG. 3, the plural closed cross-sectional cells 103a, 103b each have an axis in the vehicle width direction (a direction orthogonal to a sheet of FIG. 3). That is, the plural closed cross-sectional cells 103a, 103b each have a hollow columnar shape that has the axis in the vehicle width direction (a second direction), and are formed to continue in the front-rear direction (a first direction).

Each of the plural closed cross-sectional cells 103a, 103b has a hexagonal shape. Then, the closed cross-sectional cell 103a and the closed cross-sectional cell 103b that are adjacent to each other in the front-rear direction are formed to share a cell wall (a first cell wall) that extends in an oblique direction to the up-down direction and the front-rear direction.

In the present embodiment, each of the closed cross-sectional cells 103a, 103b does not have a regular hexagonal shape but has a distorted or irregular hexagonal shape. That is, each of the closed cross-sectional cells 103a, 103b does not have the regular hexagonal shape in which a circle is inscribed, but has the hexagonal shape in which an oval or an ellipse is inscribed in at least a part of the cell wall.

### 3. Detailed Configuration of Reinforcing Member 103

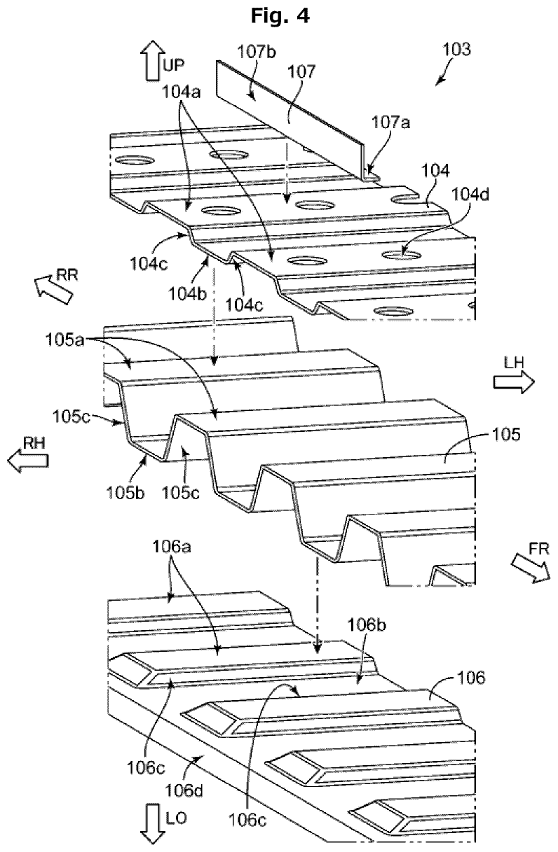

A description will be made on a detailed configuration of the reinforcing member 103 with reference to FIG. 2 to FIG. 4. FIG. 4 is an exploded perspective view illustrating the detailed configuration of the reinforcing member 103.

As illustrated in FIG. 3 and FIG. 4, the reinforcing member 103 is configured by fixing four plate members 104 to 107 including an upper plate member 104, an intermediate plate member 105, and a lower plate member 106, to each other. As illustrated in FIG. 4, the upper plate member 104 is integrally formed to have a corrugated shape by plural upper wall sections 104a, plural lower wall sections 104b, and plural slant wall sections 104c. Each of the plural upper wall sections 104a is disposed to have a plane that is orthogonal to the front-rear direction and the up-down direction. At a height position below the upper wall section 104a, each of the plural lower wall sections 104b is disposed to have a plane that is parallel to the upper wall section 104a. Each of the plural slant wall sections 104c is disposed to connect an edge in the front-rear direction of the upper wall section 104a and an edge in the front-rear direction of the lower wall section 104b.

In the upper plate member 104, through holes 104d are formed in the upper wall section 104a. The through hole 104d is a hole through which a welding rod is inserted when the intermediate plate member 105 and the lower plate member 106 are fixedly welded.

The intermediate plate member 105 is integrally formed to have a corrugated shape by plural upper wall sections 105a, plural lower wall sections 105b, and plural slant wall sections 105c. The intermediate plate member 105 is formed such that a height thereof in the up-down direction is greater than that of the upper plate member 104.

Each of the plural upper wall sections 105a is disposed to have a plane that is parallel to the upper wall section 104a and the lower wall section 104b of the upper plate member 104. At a height position below the upper wall section 105a, each of the plural lower wall sections 105b is disposed to have a plane that is parallel to the upper wall section 105a. Each of the plural slant wall sections 105c is disposed to connect an edge in the front-rear direction of the upper wall section 105a and an edge in the front-rear direction of the lower wall section 105b.

Here, the intermediate plate member 105 is formed such that a difference in height position between the upper wall section 105a and the lower wall section 105b in the up-down direction is greater than that of the upper plate member 104. Thus, a height dimension of the slant wall section 105c of the intermediate plate member 105 is greater than a height dimension of the slant wall sections 104c of the upper plate member 104.

The lower plate member 106 is integrally formed to have plural upper wall sections 106a, plural lower wall sections 106b, plural slant wall sections 106c, and a flange section 106d. The lower plate member 106 is also formed to have a corrugated shape by the plural upper wall sections 106a, the plural lower wall sections 106b, and the plural slant wall sections 106c. The lower plate member 106 is formed such that a height thereof in the up-down direction is substantially the same as that of the upper plate member 104.

Each of the plural upper wall sections 106a is disposed to have a plane that is parallel to the upper wall section 105a and the lower wall section 105b of the intermediate plate member 105. At a height position below the upper wall section 106a, each of the plural lower wall sections 106b is disposed to have a plane that is parallel to the upper wall section 106a. Each of the plural slant wall sections 106c is disposed to connect an edge in the front-rear direction of the upper wall section 106a and an edge in the front-rear direction of the lower wall section 106b. The flange section 106d is formed to hang downward from a height position at which the lower wall section 106b is provided, and has a main surface that faces rightward. The flange section 106d of the lower plate member 106 is formed to be in surface contact with an inner wall surface 101c of the outer side sill 101 illustrated in FIG. 2, and is fixedly welded to the inner wall surface 101c.

The bracket 107 is a plate member in which a horizontal wall section 107a and a vertical wall section 107b are integrally formed, and has an angled shape as a whole. The horizontal wall section 107a is fixedly welded to the upper wall section 104a of the upper plate member 104. The vertical wall section 107b is provided to stand upward from the horizontal wall section 107a, is sandwiched between the upper flange section 101a of the outer side sill 101 and the upper flange section 102a of the inner side sill 102 illustrated in FIG. 2, and is fixedly welded to the upper flange sections 101a, 102a in this state.

### 4. Shape of Closed Cross-Sectional Cells 103a, 103b

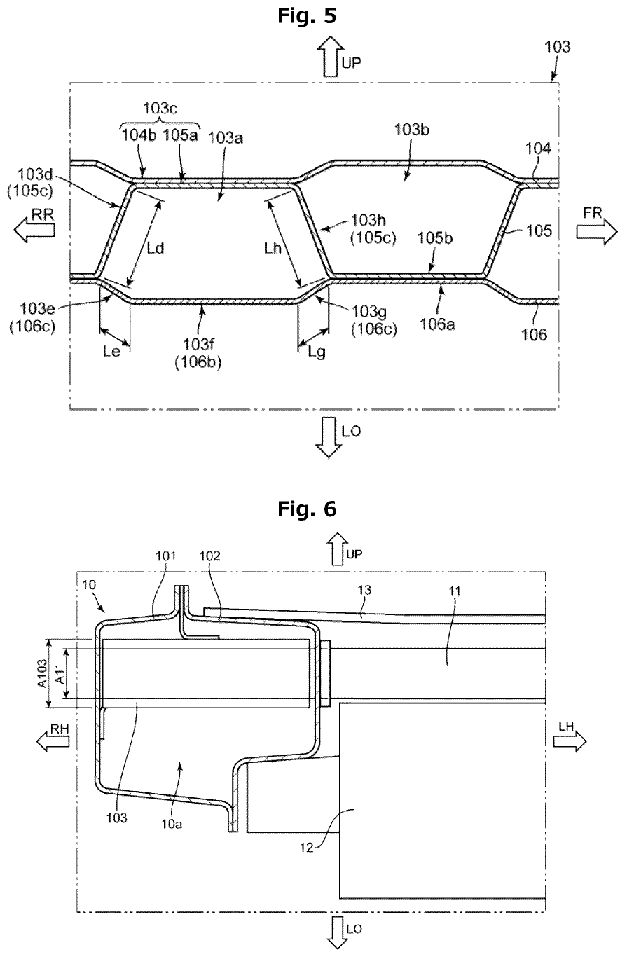

A description will be made on the shapes of the closed cross-sectional cells 103a, 103b in the reinforcing member 103 with reference to FIG. 5. Hereinafter, the shape of the closed cross-sectional cell 103a will be described, and the description on the shape of the closed cross-sectional cell 103b will not be made. However, the closed cross-sectional cell 103b has the same configuration as the closed cross-sectional cell 103a except for having a vertical reversal relationship with respect to the closed cross-sectional cell 103a.

As described above, the reinforcing member 103 is configured by combining the three plate members 104 to 106, each of which extends in the vehicle front-rear direction and is bent. As illustrated in FIG. 5, the lower wall section 104b of the upper plate member 104 and the upper wall section 105a of the intermediate plate member 105 are fixedly welded. In addition, the lower wall section 105b of the intermediate plate member 105 and the upper wall section 106a of the lower plate member 106 are fixedly welded. By fixing the three plate members 104 to 106, just as described, the closed cross-sectional cells 103a, 103b of the reinforcing member 103 are formed.

In the closed cross-sectional cell 103a, an internal space having a hexagonal cross section is surrounded by six cell walls 103c to 103h. The upper cell wall 103c is formed by superimposing the lower wall section 104b of the upper plate member 104 and the upper wall section 105a of the intermediate plate member 105. The upper slant cell walls 103d, 103h are each formed by the slant wall section 105c of the intermediate plate member 105 and are each configured to hang obliquely downward from a respective edge of the upper cell wall 103c in the front-rear direction. The upper slant cell walls 103d, 103h are cell walls, each of which is shared by the closed cross-sectional cells 103a, 103b that are adjacent to each other in the front-rear direction, and are a pair of first cell walls. That is, the reinforcing member 103 is configured that the plural closed cross-sectional cells 103a, 103b share the upper slant cell walls 103d, 103h.

The lower slant cell walls 103e, 103g are each formed by the slant wall section 106c of the lower plate member 106 and are configured to hang obliquely downward from lower edges of the upper slant cell walls 103d, 103h, respectively. The lower cell wall 103f is formed by the lower wall section 106b of the lower plate member 106. The lower cell wall 103f is configured to oppose the upper cell wall 103c in a state parallel to each other and to connect lower edges of the lower slant cell walls 103e, 103g. In the present embodiment, the lower slant cell walls 103e, 103g are third cell walls. Similarly, in the cross-sectional cells 103b, the lower cell wall is formed by the lower wall sections 105b and the upper wall sections 106a, while the upper cell wall includes the upper wall sections 104a and slant wall sections 104c.

The upper slant cell walls 103d, 103h have side lengths (side lengths in a cross section illustrated in FIG. 5) Ld, Lh, respectively. The lower slant cell walls 103e, 103g have side lengths (side lengths in the cross section illustrated in FIG. 5) Le, Lg, respectively. In this case, the closed cross-sectional cells 103a, 103b are configured such that the side lengths Ld, Lh are respectively longer than the side lengths Le, Lg. In this way, each of the closed cross-sectional cells 103a, 103b does not have the regular hexagonal shape but has the distorted hexagonal shape.

### 5. Positional Relationship Between Reinforcing Member 103 and Cross Member 11 in Up-Down Direction

A description will be made on positional relationship between the reinforcing member 103 and the cross member 11 in the up-down direction with reference to FIG. 6. In FIG. 6, the reinforcing member 103 that is accommodated in the right side sill 10 in the vehicle width direction is illustrated as an example. However, the reinforcing member 103 that is accommodated in the left side sill 10 in the vehicle width direction is also disposed to satisfy the same positional relationship as that illustrated in FIG. 6 in the up-down direction.

As illustrated in FIG. 6, the cross member 11 and the battery 12 are fixed to an outer wall surface of the inner side sill 102 of the side sill 10. A floor panel 13 is also fixed to the outer wall surface of the inner side sill 102.

The cross member 11 is disposed below the floor panel 13 and above the battery 12. An area where the cross member 11 is disposed in the up-down direction will be denoted by A11, and an area where the reinforcing member 103 is disposed in the up-down direction will be denoted by A103. In this case, when the cross member 11 and the reinforcing member 103 are viewed from one side in the vehicle width direction, the area A103 overlaps the area A11. That is, in the present embodiment, in the side view from the one side in the vehicle width direction, the reinforcing member 103 is disposed in the area that overlaps the cross member 11.

### 6. Effects

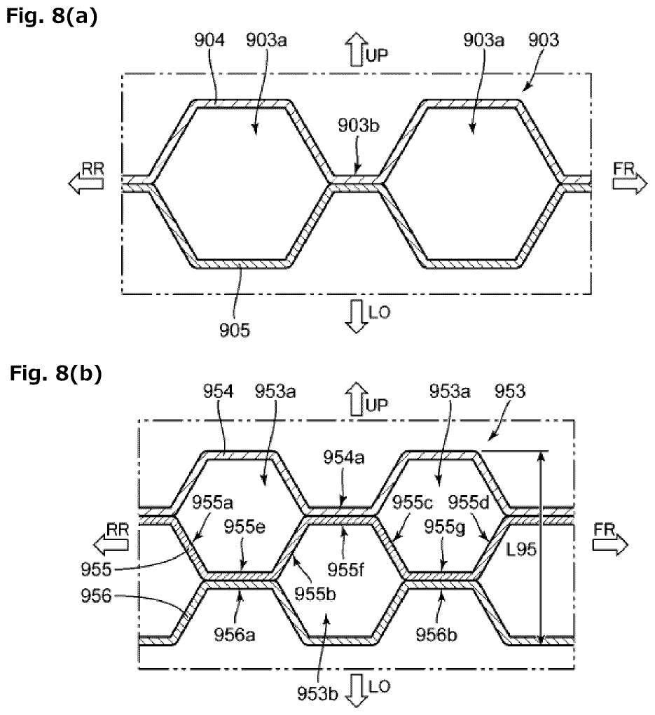

In the vehicle 1, to which the vehicle body frame structure according to the present embodiment is applied, since each of the closed cross-sectional cells 103a, 103b is formed such that the side lengths Ld, Lh of the paired upper slant cell walls (the first cell walls) 103d, 103h are respectively longer than the side lengths Le, Lg of the lower slant cell walls 103e, 103g, it is possible to secure a large cross-sectional area of the closed cross section of each of the closed cross-sectional cells 103a, 103b while making the closed cross-sectional cells 103a, 103b continue in the front-rear direction (the first direction) in comparison with a case where plural closed cross-sectional cells in the regular hexagonal shapes are formed. Therefore, in the vehicle 1, it is possible to realize a high collision energy absorption property at the time when a collision load (a side collision load) is input to the side sill 10 from the outer side in the vehicle width direction while suppressing increases in weight and manufacturing cost in comparison with a case where the configuration as illustrated in FIG. 8(b) is adopted.

In the vehicle 1, to which the vehicle body frame structure according to the present embodiment is applied, the closed cross-sectional shape of each of the closed cross-sectional cells 103a, 103b is the hexagonal shape, but the upper slant cell wall 103d and the lower slant cell wall 103g are not parallel, and the upper slant cell wall 103h and the lower slant cell wall 103e are not parallel. In other words, in the cross section illustrated in FIG. 5 and the like, each of the closed cross-sectional cells 103a, 103b does not have a true inscribed circle but is formed in the shape in which the ellipse is inscribed. Accordingly, in the present embodiment, compared to the case where the regular hexagonal cell structures continue as illustrated in FIG. 8(b), it is possible to make the plural closed cross-sectional cells 103a, 103b continue in the front-rear direction while securing the large cross-sectional area of each of the hexagonal closed cross-sectional cells 103a, 103b.

In the vehicle 1, to which the vehicle body frame structure according to the present embodiment is applied, since the reinforcing member 103 is disposed in the area that overlaps the cross member 11 in the side view from the side, when the collision load is input from the side of the vehicle 1 to the side sill 10 as the frame member, the load is highly efficiently transmitted to the cross member 11 via the reinforcing member 103. Thus, in the vehicle 1, even when the side collision load is input to the side sill 10 on one side in the vehicle width direction, the load is transmitted to the side sill 10 on an opposite side via the cross member 11, and energy can be absorbed highly efficiently.

In the vehicle 1, to which the vehicle body frame structure according to the present embodiment is applied, since the battery 12 is fixed to the side sill 10 having high rigidity, the battery 12 is securely held even when vibration is applied during travel of the vehicle 1, or the like. In the vehicle 1, even when the side collision load is input to the side sill 10 as described above, the energy is absorbed highly efficiently by the reinforcing member 103, and the load is transmitted to the cross member 11. Thus, it is possible to suppress the battery 12 from being damaged during the side collision.

In the vehicle 1, to which the vehicle body frame structure according to the present embodiment is applied, since the reinforcing member 103 is configured to include the three plate members 104 to 106, it is possible to form the reinforcing member 103 in a simpler manufacturing process than in a case where the reinforcing member 103 is integrally formed by casting or the like. In addition, even when a vehicle type is different, or design is changed, or the like, the reinforcing member 103 can be formed by flexibly changing the shape in comparison with the case where the reinforcing member 103 is formed by casting or the like.

In the vehicle 1, to which the vehicle body frame structure according to the present embodiment is applied, each of the upper slant cell walls 103d, 103h in the plural closed cross-sectional cells 103a, 103b is formed by the intermediate plate member (a second plate member) 105. Thus, it is possible to realize the configuration of the reinforcing member 103 in an optimum shape by the bent shape of the intermediate plate member 105 while considering the collision energy absorption property. Further, by having an intermediate plate member 105 that extends further in the up-down direction, e.g., is wider in the up-down direction, than the first and third plate members 104, 106 that sandwich the intermediate plate member 105, the reinforcing member 103 may provide sufficient collision energy absorption while reducing size and weight of the reinforcing member 103.

As it has been described so far, in the vehicle 1 that has the vehicle body frame structure according to the present embodiment, it is possible to realize the high collision energy absorption property while suppressing the increases in the weight and the manufacturing cost.

### First Modified Example

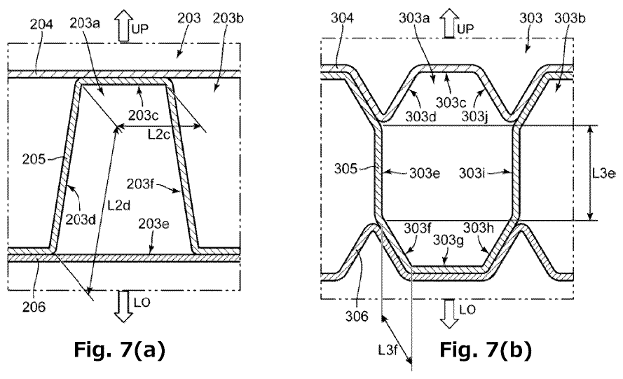

A vehicle body frame structure according to a first modified example will be described with reference to FIG. 7(a). In the vehicle body frame structure according to the present modified example, a configuration of a reinforcing member 203 that is accommodated in the inner hollow section 10a of the side sill 10 differs from that in the above embodiment, and the other configurations are the same as those in the above embodiment. Hereinafter, a description will be made on the configuration of the reinforcing member 203 as a different point from the above embodiment.

As illustrated in FIG. 7(a), in the reinforcing member 203, quadrangular closed cross-sectional cells 203a, 203b are configured to be arranged continuously in the front-rear direction in a state where the closed cross-sectional cells 203a, 203b that are adjacent to each other in the front-rear direction share a cell wall. More specifically, the reinforcing member 203 is configured to include three plate members 204 to 205. Of these, the upper plate member 204 and a lower plate member 206 are disposed to oppose each other, and each have a flat plate shape.

Meanwhile, similar to the intermediate plate member 105 in the above embodiment, the intermediate plate member 205 is bent into a corrugated shape.

In each of the closed cross-sectional cells 203a, 203b, an internal space having a quadrangular (trapezoidal) cross section is surrounded by four cell walls 203c to 203f.

In the closed cross-sectional cell 203a, the upper cell wall 203c is formed by superimposing a part of the upper plate member 204 and a bent upper wall section of the intermediate plate member 205. Meanwhile, in the closed cross-sectional cell 203b, the upper cell wall 203c is formed by a part of the upper plate member 204.

The slant cell walls 203d, 203f are each formed by a part of the intermediate plate member 205 and are each configured to hang obliquely downward from a respective edge of the upper cell wall 203c in the front-rear direction. The slant cell walls 203d, 203f are cell walls, each of which is shared by the closed cross-sectional cells 203a, 203b that are adjacent to each other in the front-rear direction, and are a pair of the first cell walls.

In the closed cross-sectional cell 203a, the lower cell wall 203e is formed by a part of the lower plate member 206 and is configured to be parallel to the upper cell wall 203c. In the closed cross-sectional cell 203b, the lower cell wall 203e is formed by superimposing a part of the lower plate member 206 and a bent lower wall section of the intermediate plate member 205.

In the closed cross-sectional cells 203a, 203b, the slant cell wall 203d and the slant cell wall 203f are disposed in a state of being not parallel to each other. That is, each of the closed cross-sectional cells 203a, 203b has, not a square, but a trapezoidal cross-sectional shape.

The slant cell wall 203d has a side length (a side length in a cross section illustrated in FIG. 7(a)) L2d. The upper cell wall 203c has a side length (a side length in a cross section illustrated in FIG. 7(a)) L2c. In this case, the closed cross-sectional cells 203a, 203b are each configured that the side length L2d is longer than the side length L2c.

The same effects as those in the above embodiment can be exerted for the vehicle, to which the vehicle body frame structure according to the present modified example is applied. That is, the present modified example differs from the above embodiment in that the closed cross-sectional cells 203a, 203b each have the quadrangular shape (n=4), but the other points are the same as the above embodiment. In addition, the closed cross-sectional cells 203a, 203b are configured that the length L2d of each of the cell walls (the slant cell walls) 203d, 203f shared by the closed cross-sectional cells 203a, 203b that are adjacent to each other in the vehicle front-rear direction is longer than the length L2c of the one cell wall (the upper cell wall) 203c other than the slant cell walls 203d, 203f in the closed cross-sectional cells 203a, 203b. Therefore, the same effects as those in the above embodiment can be exerted for the vehicle, to which the vehicle body frame structure according to the present modified example is applied.

### Second Modified Example

A vehicle body frame structure according to a second modified example will be described with reference to FIG. 7(b). In the vehicle body frame structure according to the present modified example, a configuration of a reinforcing member 303 that is accommodated in the inner hollow section 10a of the side sill 10 differs from those in the above embodiment and the above first modified example, and the other configurations are the same as those in the above embodiment and the above first modified example. Hereinafter, a description will be made on the configuration of the reinforcing member 303 as a different point from the above embodiment and the above first modified example.

As illustrated in FIG. 7(b), in the reinforcing member 303, octagonal closed cross-sectional cells 303a, 303b are configured to continue in the front-rear direction in a state where the closed cross-sectional cells 303a, 303b that are adjacent to each other in the front-rear direction share a cell wall. More specifically, the reinforcing member 303 is configured to include three plate members 304 to 305. Of these, similar to each of the plate members 104 to 106 in the above embodiment, each of the plate members 304 to 306 is bent to have a corrugated shape in the up-down direction.

In each of the closed cross-sectional cells 303a, 303b, an internal space having an octagonal cross section is surrounded by eight cell walls 303c to 303j.

In the closed cross-sectional cell 303a, the upper cell wall 303c and the upper slant cell walls 303d, 303j are each formed by a part of the upper plate member 304. Meanwhile, in the closed cross-sectional cell 303b, the upper cell wall 303c and the upper slant cell walls 303d, 303j are each formed by superimposing a part of the upper plate member 304 and a part of the intermediate plate member 305.

In the closed cross-sectional cells 303a, 303b, vertical cell walls 303e, 303i are each formed by a part of the intermediate plate member 305 and are configured to hang obliquely downward from lower edges of the upper slant cell walls 303d, 303j, respectively. The vertical cell walls 303e, 303i are cell walls, each of which is shared by the closed cross-sectional cells 303a, 303b that are adjacent to each other in the front-rear direction, and are a pair of the first cell walls.

In the closed cross-sectional cell 303a, the lower cell wall 303g and the lower slant cell walls 303f, 303h are each formed by superimposing a part of the lower plate member 306 and a part of the intermediate plate member 305. Meanwhile, in the closed cross-sectional cell 303b, the lower cell wall 303g and the lower slant cell walls 303f, 303h are each formed by a part of the lower plate member 306.

In the closed cross-sectional cells 303a, 303b, the vertical cell wall 303e and the vertical cell wall 3031 are disposed in a state of opposing each other in parallel. However, each of the closed cross-sectional cells 303a, 303b does not have a regular octagonal shape but is configured that a length L3e of each of the vertical cell walls 303e, 303i is longer than a length of at least one of the other cell walls 303c, 303d, 303f to 303h, 303j. More specifically, the vertical cell walls 303e, 303i each have the side length (a side length in a cross section illustrated in FIG. 7(b)) L3e. In addition, the lower slant cell wall 303f has a side length (a side length in the cross section illustrated in FIG. 7(b)) L3f. In this case, the closed cross-sectional cells 303a, 303b are each configured that the side length L3e is longer than the side length L3f.

The same effects as those in the above embodiment and the above first modified example can be exerted for the vehicle, to which the vehicle body frame structure according to the present modified example is applied. That is, the present modified example differs from the above embodiment and the above first modified example in that the closed cross-sectional cells 303a, 303b each have the octagonal shape (n=8), but the other points are the same as the above embodiment and the above first modified example. In addition, the closed cross-sectional cells 303a, 303b are configured that the length L3e of each of the cell walls (the vertical cell walls) 303e, 303i shared by the closed cross-sectional cells 303a, 303b that are adjacent to each other in the vehicle front-rear direction is longer than the length L3f of the at least one cell wall (the lower slant cell wall) 303f other than the vertical cell walls 303e, 303i in the closed cross-sectional cells 303a, 303b. Therefore, the same effects as those in the above embodiment and the above first modified example can be exerted for the vehicle, to which the vehicle body frame structure according to the present modified example is applied.

### Other Modified Examples

In the above embodiment, the reinforcing member 103 that includes the plural closed cross-sectional cells 103a, 103b, each of which has the hexagonal cross-sectional shape, is adopted. In the above first modified example, the reinforcing member 203 that includes the plural closed cross-sectional cells 203a, 203b, each of which has the quadrangular cross-sectional shape, is adopted. In the above second modified example, the reinforcing member 303 that includes the plural closed cross-sectional cells 303a, 303b, each of which has the octagonal cross-sectional shape, is adopted. However, the disclosure is not limited thereto. The cross-sectional shape of the closed cross-sectional cell may be a decagon, a dodecagon, or greater as long as it is an n-sided polygon (n: an even number of 4 or greater). Further, while the above illustrate first and third plates that have a same width along the up-down direction, the first and third plates may have different widths along the up-down direction from each other.

In the above embodiment and the above first and second modified examples, the reinforcing members 103, 203, 303 are each accommodated in the hollow section 10a of the side sill 10. However, the disclosure is not limited thereto. For example, the configuration of the disclosure may be adopted as a reinforcing member that is accommodated in a hollow section of a pillar (a front pillar, a center pillar, or a rear pillar).

In the above embodiment and the above second modified example, the three bent plate members 104 to 106, 304 to 306 are fixed to each other to constitute the reinforcing members 103, 303, and the plate members 104 to 106, 304 to 306 are superimposed such that bent corner portions of the plate members 104 to 106, 304 to 306 match each other, i.e., front-rear direction overlap in the up-down and. Alternatively, the corner portions related to bending of the plate members may be mismatched or offset in the front-rear direction and/or the up-down direction of the vehicle within a range of a manufacturing error.

In the above embodiment and the above first and second modified examples, the reinforcing members 103, 203, 303 are configured by fixing the plural plate members including the three plate members 104 to 106, 204 to 206, 304 to 306 to each other, respectively. Alternatively, a reinforcing member, at least a part of which is integrally formed by casting, can also be adopted.

In the above embodiment and the above first and second modified examples, in the side view from the side (the one side in the vehicle width direction) of the vehicle 1, the reinforcing members 103, 203, 303 are each disposed in the area that overlaps the cross member 11. Alternatively, the reinforcing member may be disposed at a position that does not overlap the cross member and have a shift in the up-down direction in the side view from the one side in the vehicle width direction.

In the above embodiment and the above first and second modified examples, the casing of the battery 12 is directly fixed to the side sill 10. Alternatively, the battery may be fixed to the cross member or may be fixed to the floor panel.

In the above first modified example, of the three plate members 204 to 206 that form the reinforcing member 203, the plate members 204, 206 are not bent and each have the flat plate shape. Alternatively, each of the upper plate member 204 and the lower plate member 206 may also be bent to have the corrugated shape in the up-down direction.

### REFERENCE SIGNS LIST

1: vehicle
1b: floor section
10: side sill (frame member)
11: cross member
101: outer side sill
102: inner side sill
103, 203, 303: reinforcing member
103a, 103b, 203a, 203b, 303a, 303b: closed cross-sectional cell (cell)
103d, 103h: upper slant cell wall (first cell wall)
103e, 103g, 303d, 303f, 303h, 303j: lower slant cell wall
104, 204, 304: upper plate member
105, 205, 305: intermediate plate member
106, 206, 306: lower plate member
203c: upper cell wall
203d, 203f: slant cell wall (first cell wall)
303e, 303i: vertical cell wall (first cell wall)

1. A vehicle body frame structure for a vehicle comprising:
a frame member having a hollow section therein, the frame member extending in a first direction; and
a reinforcing member in the hollow section of the frame member, the reinforcing member having a plurality of closed cells, each cell of the plurality of closed cells is defined by plural cell walls into a hollow columnar shape that has an axis in a second direction intersecting the first direction, the plurality of closed cells are arranged continuously in the first direction, wherein
each cell of the plurality of closed cells in the reinforcing member has an n-sided polygon (n: an even number of 4 or greater) in an orthogonal cross section to the second direction,
cells adjacent to each other in the first direction share one of the plural cell walls designated as a first cell wall, and
a side length of the first cell wall in the orthogonal cross section in each cell is longer than a side length of at least one cell wall of other cell walls that form the cell.

2. The vehicle body frame structure for the vehicle according to claim 1, wherein
in the orthogonal cross section, each cell of the plurality of closed cells has a hexagonal shape, and has:
paired second cell walls that extend in the first direction and oppose to each other in a third direction that is orthogonal to the first direction; and paired third cell walls, each of which connects an end side in the first direction of one cell wall of the paired second cell walls and a respective end side in the third direction of a pair of the first cell walls, and
each of the plural cells is formed so that the side length of the first cell wall is longer than a side length of the third cell wall.

3. The vehicle body frame structure for the vehicle according to claim 2, wherein
the frame member is a side sill on an outer side in a vehicle width direction of a floor section of the vehicle and extends in a front-rear direction of the vehicle,
a cross member having a first end connected to the side sill, the cross member extending in the vehicle width direction and is in the floor section of the vehicle, and
in a side view from a side of the vehicle, the reinforcing member is in an area that overlaps the cross member.

4. The vehicle body frame structure for the vehicle according to claim 3, wherein
a battery is in the floor section, and
the battery is fixed to the side sill.

5. The vehicle body frame structure for the vehicle according to claim 4, wherein
the reinforcing member is formed by fixing three plate members, each of which extends in the first direction and is bent, to each other.

6. The vehicle body frame structure for the vehicle according to claim 3, wherein
the reinforcing member is formed by fixing three plate members, each of which extends in the first direction and is bent, to each other.

7. The vehicle body frame structure for the vehicle according to claim 1, wherein
the reinforcing member is formed by fixing three plate members, each of which extends in the first direction and is bent, to each other.

8. The vehicle body frame structure for the vehicle according to claim 7, wherein
the three plate members include a first plate member, a second plate member, and a third plate member that are disposed from one side toward another side in the third direction,
in each of the plural cells, the first plate member and the third plate member form the paired second cell walls and the paired third cell walls, and
in each of the plural cells, the second plate member forms the paired first cell walls.

9. The vehicle body frame structure for the vehicle according to claim 8, wherein the three plate members include a first plate member, a second plate member, and a third plate member, wherein the second plate member is between the first and third plate members and is wider in the second direction than the first and third plate members.

10. The vehicle body frame structure for the vehicle according to claim 8, wherein a bent portions of the three plate members are aligned where the plate members are joined.

11. The vehicle body frame structure for the vehicle according to claim 1, wherein
the reinforcing member is formed by fixing a first plate member, a second plate member, and a third plate member, each of which extends in the first direction, to each other, wherein the first plate member is flat, the second plate member is flat, and the third plate member is bent and between the first and second plater members.

12. The vehicle body frame structure for the vehicle according to claim 1, wherein
the reinforcing member includes a first plate member, a second plate member, and a third plate member, wherein the second plate member is between the first and third plate members, is bent and is wider in the second direction than the first and third plate members.

13. The vehicle body frame structure for the vehicle according to claim 12, wherein the first and third plate members have a same width in the second direction.

14. A vehicle body frame structure for a vehicle comprising:
a frame member having a hollow section therein, the frame member extending in a first direction; and
a reinforcing member in the hollow section of the frame member, the reinforcing member including a first plate member, a second plate member, and a third plate member, wherein the second plate member is between the first and third plate members, is bent, and is wider in the second direction than the first and third plate members.

15. The vehicle body frame structure for the vehicle according to claim 14, wherein at least one of the first and third plate members is bent.

16. The vehicle body frame structure for the vehicle according to claim 15, wherein both of the first and third plate members are bent.

17. The vehicle body frame structure for the vehicle according to claim 14, wherein at least one of the first and third plate members is flat.

18. The vehicle body frame structure for the vehicle according to claim 17, wherein both of the first and third plate members are flat.

19. The vehicle body frame structure for the vehicle according to claim 14, wherein both of the first and third plate members are flat.
